(19) United States
(12) Patent Application Publication
(10) Pub. No.: US 2015/0075129 A1
(43) Pub. Date: Mar. 19, 2015

(54) Portable Tobacco Barn

(71) Applicant: Robert F. Mooneyhan, Greeneville, TN (US)

(72) Inventor: Robert F. Mooneyhan, Greeneville, TN (US)

(21) Appl. No.: 14/031,076

(22) Filed: Sep. 19, 2013

(51) Int. Cl. A24B 1/02; A01D 45/16

(52) U.S. Cl. CPC A24B 1/02; A01D 45/16
USPC 56/27.5; 34/201

(57) ABSTRACT

A portable tobacco barn that includes a frame with arm members to support curing rods holding harvested tobacco stalks. Once the portable tobacco barn is loaded to capacity, the portable tobacco barn is covered with a protective cover sheet, and the loaded harvested tobacco stalks on curing rods then remain loaded in the portable tobacco barn during the drying and curing process, thereby eliminating the need to handle the harvested tobacco a second time and minimizing the number of times that the harvested tobacco must be handled.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains generally to equipment for use in harvesting and curing tobacco. More particularly, this invention pertains to a portable apparatus for drying tobacco.

2. Description of the Related Art

To allow leaves of tobacco to dry before processing into end products, stalks of tobacco are hung in drying barns for a period of time until the tobacco leaves have dried.

U.S. Pat. No. 3,937,227 discloses a tobacco leaf drying system having an air-inlet opening and closing device which is operated independently of the wet-bulb temperature control device, and in operation, gradually starts to open the inlet when the mesophyll drying stage begins, and closes the inlet by the end of the stem drying stage. This ventilates the humid air having passed through the leaf layers in amounts almost equal to the outdoor air introduced into the chamber, so as to slowly change the mixing ratio of the fresh air taken in and, thereby maintaining the chamber humidity at a proper level while advancing a successful drying operation.

U.S. Pat. No. 4,790,334 discloses a portable curing frame is provided particularly adapted for use with an automated tobacco harvester. The curing frame includes a substantially rectangular frame member including a series of slotted tracks, in the form of slotted tubes, specially designed for receiving a notched portion of the plant stalks.

U.S. Pat. No. 5,168,642 discloses a tobacco drying apparatus for holding stalks of tobacco in a drying barn, in which a stalk of tobacco may be inserted upwardly into the drying apparatus and is automatically held against undesired downward removal therefrom.

In various methods known in the art, harvested tobacco stalks must be handled a first time when loaded from the field onto a harvesting apparatus, and then must be handled a first time when loaded from the harvesting apparatus into a drying barn. It is desirable to have an apparatus, or a system or method, that eliminates the need to handle the harvested tobacco a second time, or that minimizes the number of times that the harvested tobacco must be handled.

### BRIEF SUMMARY OF THE INVENTION

In some of its many embodiments, the present general inventive concept includes a portable tobacco barn that includes a frame with arm members to support curing rods holding harvested tobacco stalks. Generally, once the portable tobacco barn is loaded to capacity, the portable tobacco barn is covered with a protective cover sheet, and the loaded harvested tobacco stalks on curing rods then remain loaded in the portable tobacco barn during the drying and curing process.

A portable tobacco barn according to various embodiments of the present general inventive concept is capable of being loaded in the field and then transported, with the harvested tobacco stalks, to another location. In many uses of embodiments of the present general inventive concept, and in many methods according to the present general inventive concept, the portable tobacco barn is loaded with harvested tobacco stalks on curing rods in the field, and the loaded harvested tobacco stalks on curing rods then remain loaded in the portable tobacco barn during and throughout the curing process. Compared to other methods used in the art, use of the portable tobacco barn minimizes the number of times that personnel must physically touch or handle harvested tobacco stalks while preparing them for curing.

In some of its many embodiments, the present general inventive concept includes a portable tobacco barn to receive and hold harvested tobacco stalks on curing rods, the portable tobacco barn including a portable frame assembly including a mid-level set of arm members to support a curing rod holding harvested tobacco stalks and a level set of arm members to support a curing rod holding harvested tobacco stalks and a protective cover sheet to cover said portable frame assembly.

In some embodiments, the arm members are fabricated from wood.

In some embodiments, the portable frame assembly is fabricated from wood.

In some embodiments, the portable frame assembly is fabricated from galvanized metal.

In some embodiments, the portable frame assembly is fabricated from aluminum, PVC, or a plastic material.

Some embodiments further include vertical support members and arm support members to support the arm members, the arm support members being attached to the vertical support members.

In some of its many embodiments, the present general inventive concept includes a portable tobacco barn to receive and hold harvested tobacco stalks on curing rods, including a portable frame assembly including a set of arm members to support curing rods holding harvested tobacco stalks and a protective cover sheet to cover said portable frame assembly.

In some embodiments, the arm members are fabricated from wood.

In some embodiments, the portable frame assembly is fabricated from wood.

In some embodiments, the portable frame assembly is fabricated from galvanized metal.

In some embodiments, the portable frame assembly is fabricated from aluminum, PVC, or a plastic material.

Some embodiments further include vertical support members and arm support members to support the arm members, the arm support members being attached to the vertical support members.

In some methods according to the present general inventive concept, a method of harvesting tobacco includes supplying a portable frame assembly including a mid-level set of arm members to support curing rods with affixed harvested tobacco stalks and a top-level set of arm members to support curing rods with affixed harvested tobacco stalks, delivering said portable frame assembly to a field of tobacco plants, affixing harvested tobacco stalks to curing rods, loading said curing rods with affixed harvested tobacco stalks onto said mid-level set of arm members to support curing rods with affixed harvested tobacco stalks and said top-level set of arm members to support curing rods with affixed harvested tobacco stalks, covering said portable frame assembly with a protective cover sheet, said protective cover sheet covering the top and sides of said portable frame assembly, said protective cover sheet having corners, tying down said corners of said protective cover sheet with fastening devices, and removing the portable frame assembly from the field of tobacco plants.

In some embodiments, the portable frame assembly is fabricated from wood.

In some embodiments, the portable frame assembly is fabricated from galvanized metal.

Use of a portable tobacco barn allows for “one-touch” harvesting of tobacco. Whereas in other methods known in the art, the harvested tobacco stalks must be handled a first time when loaded from the field onto a harvesting apparatus, and then must be handled a first time when loaded from the harvesting apparatus into a drying barn, use of a portable tobacco barn according to the present general inventive concept eliminates the second step.

The present general inventive concept, then, in some of its many example embodiments, eliminates the need to handle the harvested tobacco a second time and minimizes the number of times that the harvested tobacco must be handled.

### BRIEF DESCRIPTION OF THE DRAWINGS

The above-mentioned and additional features of the invention will become more clearly understood from the following detailed description of the invention read together with the drawings in which:

FIG. 1 is a perspective view of one example embodiment of the present general inventive concept, showing a portable tobacco barn in a tobacco field;

FIG. 2 is a perspective view of the example embodiment of FIG. 1, showing the portable tobacco barn in the bed of a barn cart;

FIG. 3 is a perspective view of the example embodiment shown in FIGS. 1 and 2;

FIG. 4 is a perspective view of the example embodiment shown in FIGS. 1-3, showing curing rods holding tobacco stalks being loaded onto arm members of the portable tobacco barn;

FIG. 5 is a side view of the example embodiment shown in FIGS. 1-4, showing curing rods holding tobacco stalks loaded onto arm members of the portable tobacco barn and a cover sheet covering the portable tobacco barn;

FIGS. 6A through 6G illustrate a method of using a portable tobacco barn according to one example embodiment of the present general inventive concept; and

FIG. 7 is a side view of a portable tobacco barn according to one example embodiment of the present general inventive concept.

### DETAILED DESCRIPTION OF THE INVENTION

In some of its many embodiments, the present general inventive concept includes a portable tobacco barn that includes a frame with arm members to support curing rods holding harvested tobacco stalks. Generally, once a full complement of curing rods holding harvested tobacco stalks are loaded onto the portable tobacco barn—that is, once the portable tobacco barn is loaded to capacity—the portable tobacco barn is covered with a protective cover sheet. In many uses of the present invention and methods, the portable tobacco barn is loaded with harvested tobacco stalks on curing rods in the field, and the loaded harvested tobacco stalks on curing rods then remain loaded in the portable tobacco barn during the curing process. Compared to other methods used in the art, use of the portable tobacco barn minimizes the number of times that personnel must physically touch or handle harvested tobacco stalks while preparing them for curing.

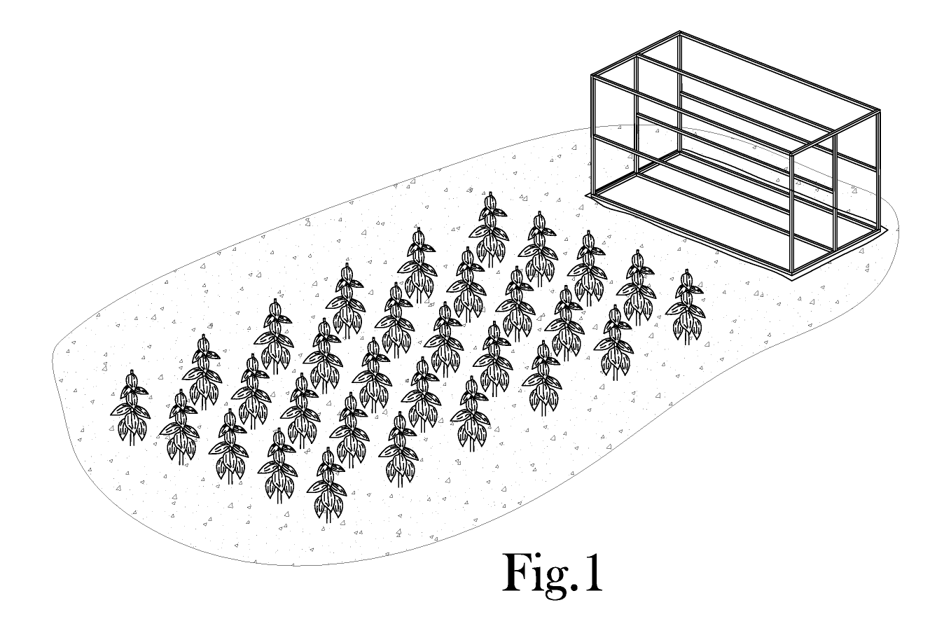

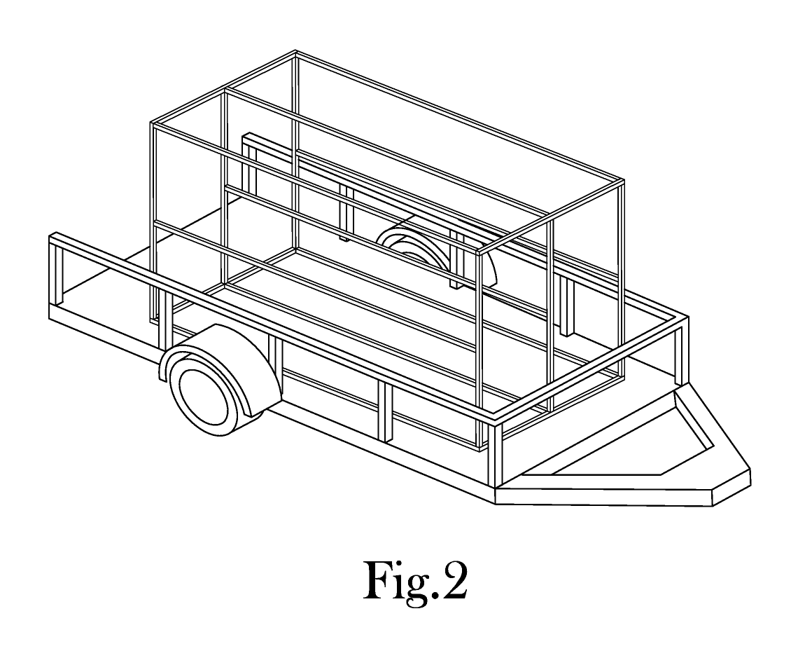

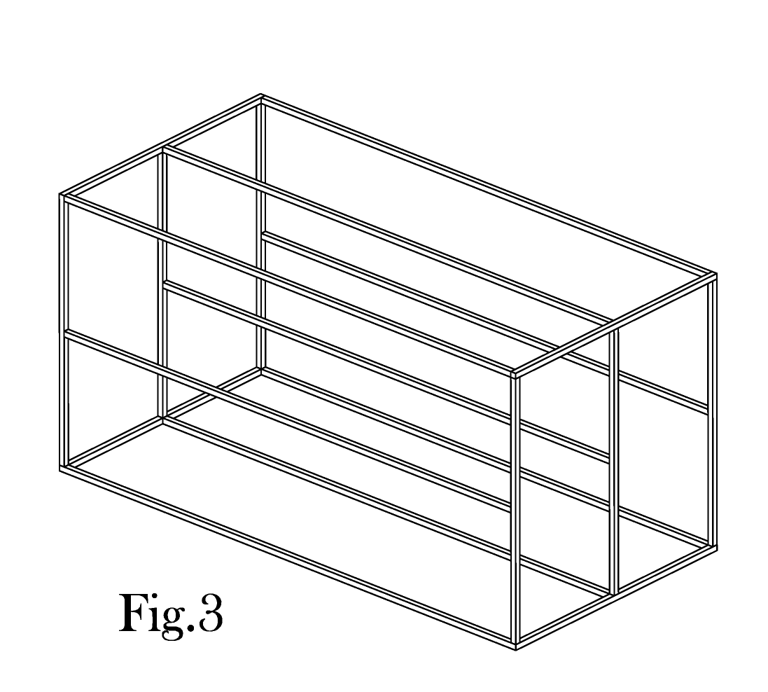

Turning to the Figures, FIG. 1 illustrates one example embodiment of a system according to the present general inventive concept. In FIG. 1, a portable tobacco barn 10 is positioned in a field of tobacco plants 20. Generally, the portable tobacco barn 10 is positioned on a ground cover sheet 30 fabricated from plastic or some comparable material; the ground cover sheet 30 helps to avoid the introduction of contaminants or water into the portable tobacco barn 10 during later stages of use. Generally, the portable tobacco barn 10 is delivered to a location in a field of tobacco plants 20 on a barn cart 40, as shown in FIG. 2. Generally, the barn cart 40 has a front end 41 and a back end 42. In several embodiments, the barn cart 40 has wheels 43, 44 positioned in such a way that the bed 46 of the barn cart 40 is inclined by lifting the front end 41 of the barn cart 40, allowing the portable tobacco barn 10 to slide off the back end 42 of the barn cart 40 onto the ground. As shown in detail in FIG. 3, the illustrated example embodiment barn cart 10 includes three lateral base members 12a, 12b, 12c, three lower level arm members 14a, 14b, 14c, and three top level arm members 16a, 16b, 16c. Also, the illustrated example embodiment barn cart 10 includes two cross-beam base members 17a, 17b, one at each end of the tobacco barn 10, and two cross-beam top members 18a, 18b, one at each end of the tobacco barn 10. Each cross-beam base member 17a, 17b connects to all three lateral base members 12a, 12b, 12c, and each cross-beam top member 18a, 18b connects to all three top level arm members 16a, 16b, 16c. At one end of the tobacco barn 10, the cross-beam base member 17a is connected to the cross-beam top member 18a through three vertical support members 19a, 19b, 19c. At the other end of the tobacco barn 10, the cross-beam base member 17b is connected to the cross-beam top member 18b through three vertical support members 19d, 19e, 19f. The vertical support members 19a and 19d help to support the lower level arm member 14a and the top level arm member 16a. The vertical support members 19b and 19e help to support the lower level arm member 14b and the top level arm member 16b. The vertical support members 19c and 19f help to support the lower level arm member 14c and the top level arm member 16c.

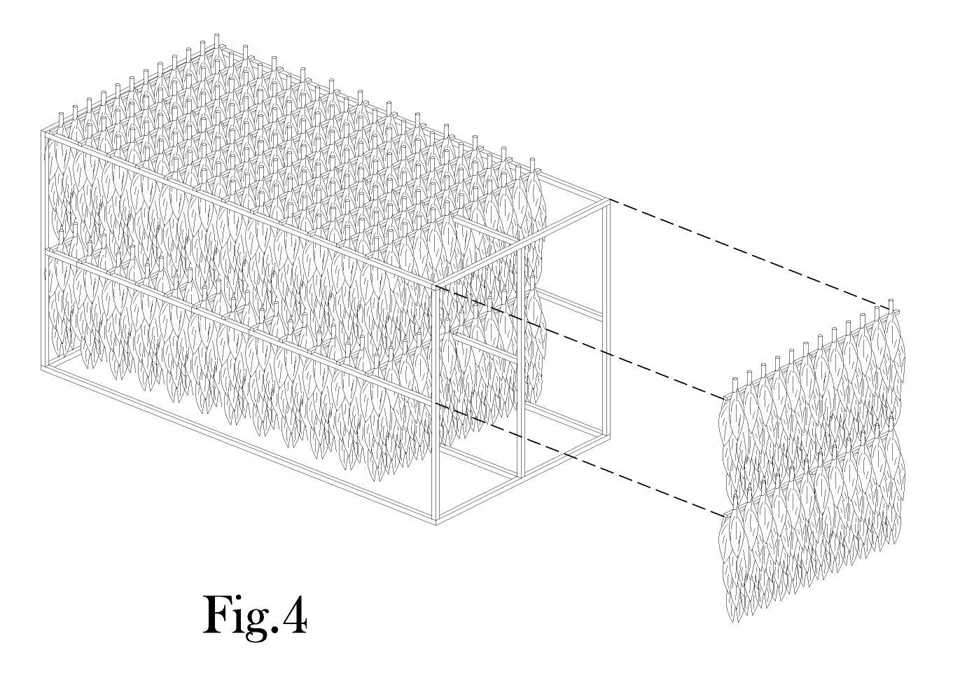

FIG. 4 illustrates one example embodiment of the present general inventive concept in use. As shown in FIG. 4, harvested tobacco stalks are hung from a curing rod, and the curing rod is then positioned between two arm members of the portable tobacco barn 10, such that one end of the curing rod rests on each arm member. Thus, in the illustrated example, a number of harvested tobacco stalks 55 hang from a curing rod 50. The curing rod 50 includes a first end 51 and a second end 52. The curing rod 50 is elevated and then lowered onto arm members of the portable tobacco barn 10, such that the first end 51 of the curing rod 50 is resting on and supported by the first top level arm member 16a and the second end 52 of the curing rod 50 is resting on and supported by the first top level arm member 16b.

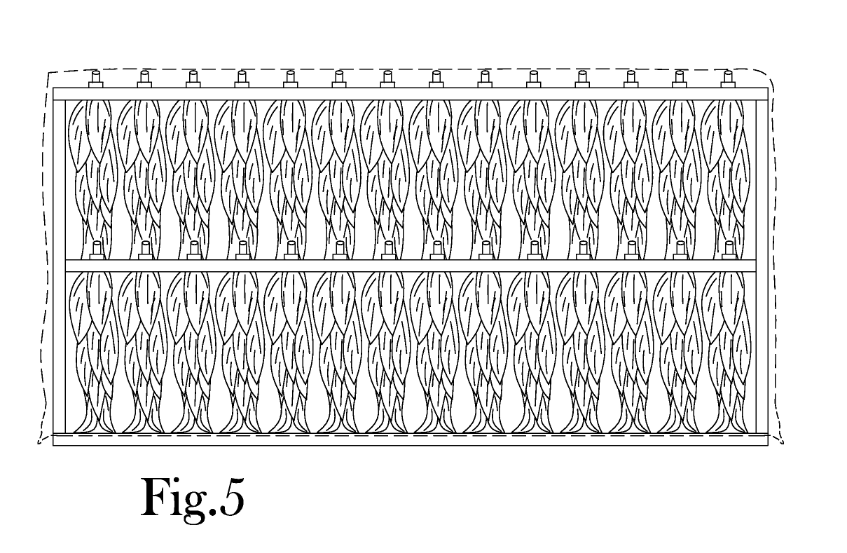

As shown in FIG. 4, the example embodiment portable tobacco barn 10 is capable of accommodating four loaded curing rods in which the hanging tobacco stalks occupy approximately the same vertical plane. That is, as the portable tobacco barn 10 is being loaded with curing rods holding harvested tobacco stalks, the curing rods are loaded in such a way that all four curing rods that comprise a single panel 57 or layer of harvested tobacco stalks are loaded before any additional curing rods are subsequently loaded. After a certain number of curing rods holding harvested tobacco stalks are loaded onto the portable tobacco barn 10, the portable tobacco barn 10 will be at capacity. Then protective cover sheet 60 covers the top and four sides of the portable tobacco barn 10, as illustrated in FIG. 5, which shows a side view of the example embodiment portable tobacco barn 10 with the tobacco stalks and curing rods loaded and the protective cover sheet 60, shown in phantom, covering the top and four sides of the portable tobacco barn 10.

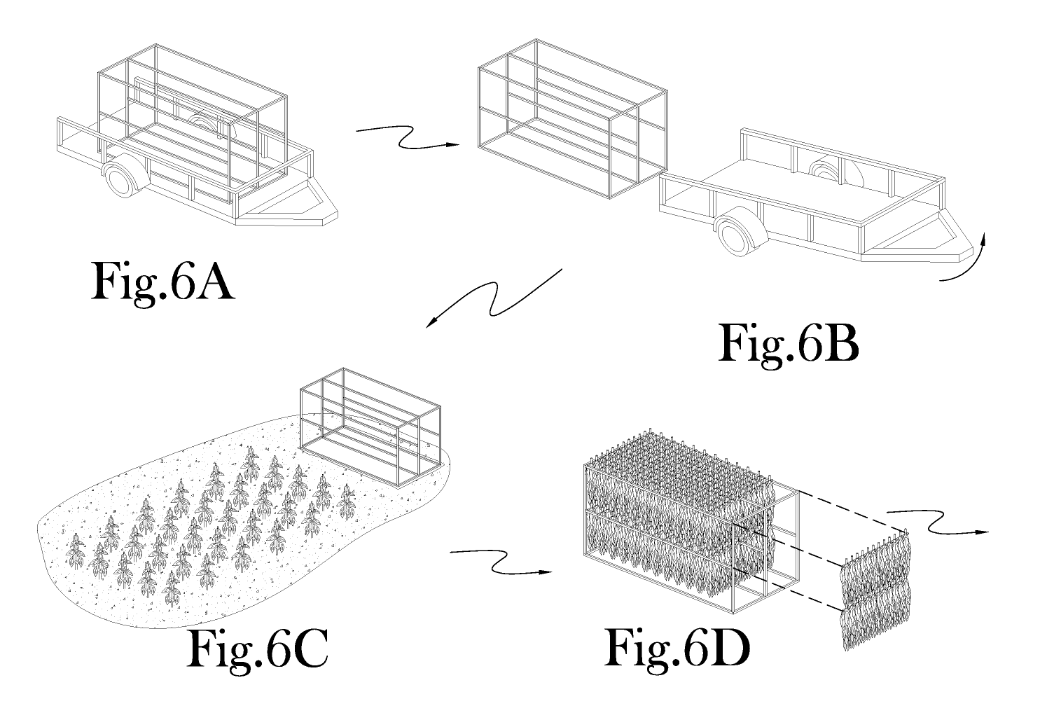

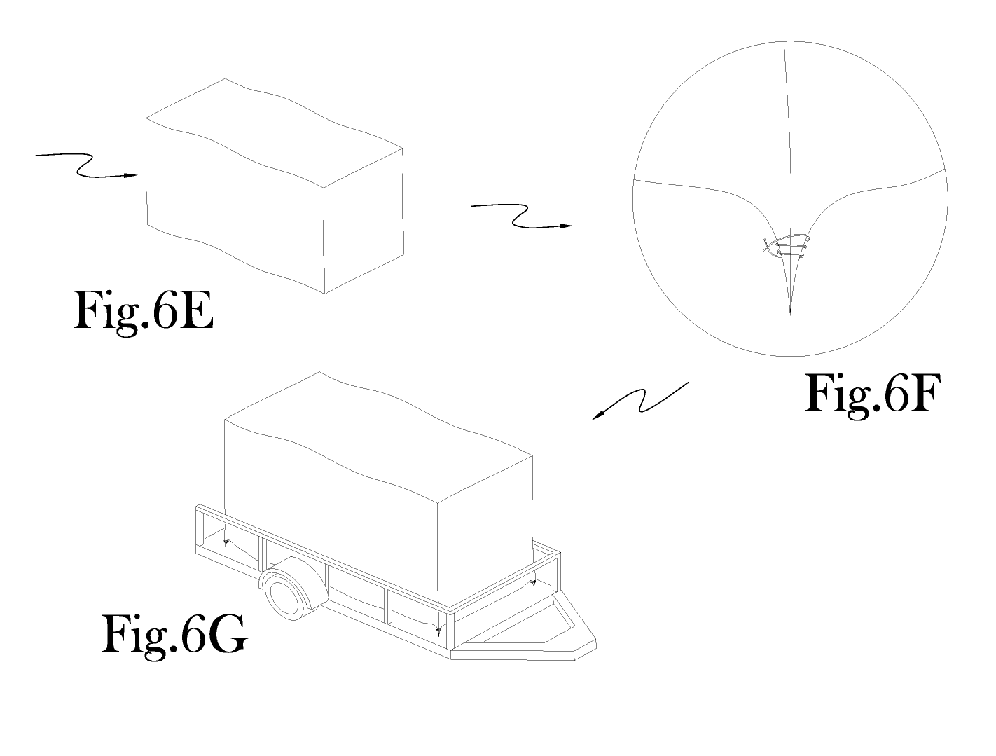

FIGS. 6A through 6G illustrate one example of a method for using a portable tobacco barn 10 according to the present general inventive concept. As shown, in FIG. 6A, the portable tobacco barn 10 is delivered to a location of use in a barn cart 40, and the barn cart 40 is elevated at one end in order to allow the portable tobacco barn 10 to slide off of the bed of the barn cart onto the ground, as shown in FIG. 6B. Often, a ground cover sheet is positioned on the ground where the portable barn cart lands after leaving the barn cart 40. FIG. 6C shows the portable tobacco barn 10 in a field of tobacco plants 20, with the portable tobacco barn resting on a ground cover sheet 30. FIG. 6D shows the portable tobacco barn 10 being loaded with harvested tobacco stalks on curing rods. After the harvested tobacco stalks on curing rods have been loaded onto the tobacco barn 10, the top and sides of the tobacco barn 10 are covered with a protective cover sheet 60, as shown in FIG. 6E. In some embodiments, fastening devices are used to secure the corners of the protective cover sheet 60, such as the tie 65 shown in FIG. 6F, which shows a close-up view of one corner of the protective cover sheet 60. With the protective cover sheet 60 in place on the portable tobacco barn 10, the portable tobacco barn 10 is loaded back onto a barn cart 40, as shown in FIG. 6G. Once loaded onto the barn cart 40, the portable tobacco barn 10 can be moved to some other location to allow the harvested tobacco to cure.

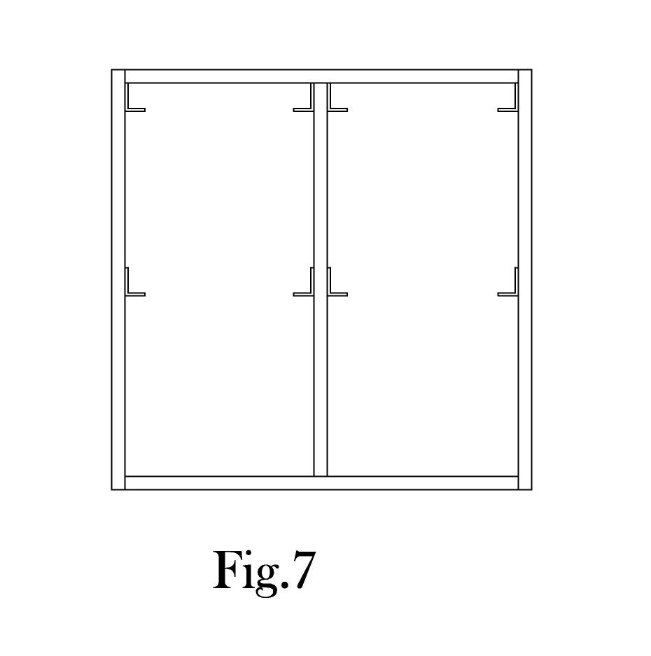

A portable tobacco barn according to the present general inventive concept is capable of being fabricated from a variety of materials. In some embodiments, such as the example embodiment illustrated in FIGS. 1-5 supra, the portable tobacco barn 10 is fabricated from wood. FIG. 7 illustrates one alternate example embodiment of a portable tobacco barn according to the present general inventive concept. As shown in FIG. 7, a portable tobacco barn 70 is fabricated from galvanized pipe, shown here in a side-on from one end of the portable tobacco barn 70 and looking along the longitudinal axis of the portable tobacco barn 70. In this example embodiment portable tobacco barn 70, three vertical support members 79a, 79b, 79c connect a base cross-beam member 77 and a top cross-beam member 78. On the vertical support members 79a, 79b, 79c, mid-level arm support members 75a, 75b, 75c, 75d or shelves are attached to the vertical support members (for example, by welding); arm members or curing rods then rest on the mid-level arm support members 75a, 75b, 75c, 75d. Similarly, top-level arm support members 76a, 76b, 76c, 76d or shelves are attached to the vertical support members (for example, by welding); arm members or curing rods then rest on the mid-level arm support members 76a, 76b, 76c, 76d.

In some embodiments of the present general inventive concept, a portable tobacco barn is fabricated from aluminum. In some embodiments of the present general inventive concept, a portable tobacco barn is fabricated from some other metal. In some embodiments of the present general inventive concept, a portable tobacco barn is fabricated from PVC. In some embodiments of the present general inventive concept, a portable tobacco barn is fabricated from a plastic material or composite. Other variants and embodiments will be apparent to those of ordinary skill in the art, and these other variants and embodiments are contemplated and embraced by the present general inventive concept.

A portable tobacco barn according to various embodiments of the present general inventive concept is capable of being loaded in the field and then transported, with the harvested tobacco stalks, to another location. In many uses of embodiments of the present general inventive concept, and in many methods according to the present general inventive concept, the portable tobacco barn is loaded with harvested tobacco stalks on curing rods in the field, and the loaded harvested tobacco stalks on curing rods then remain loaded in the portable tobacco barn during and throughout the curing process. Compared to other methods used in the art, use of the portable tobacco barn minimizes the number of times that personnel must physically touch or handle harvested tobacco stalks while preparing them for curing. Use of a portable tobacco barn allows for “one-touch” harvesting of tobacco. Whereas in other methods known in the art, the harvested tobacco stalks must be handled a first time when loaded from the field onto a harvesting apparatus, and then must be handled a first time when loaded from the harvesting apparatus into a drying barn, use of a portable tobacco barn according to the present general inventive concept eliminates the second step.

The present general inventive concept, then, in some of its many example embodiments, eliminates the need to handle the harvested tobacco a second time and minimizes the number of times that the harvested tobacco must be handled.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A portable tobacco barn to receive and hold harvested tobacco stalks on curing rods, comprising:
a portable frame assembly including a mid-level set of arm members to support a curing rod holding harvested tobacco stalks and a level set of arm members to support a curing rod holding harvested tobacco stalks; and
a protective cover sheet to cover said portable frame assembly.

2. The portable curing frame of claim 1 wherein said arm members are fabricated from wood.

3. The portable curing frame of claim 1 wherein said portable frame assembly is fabricated from wood.

4. The portable curing frame of claim 1 wherein said portable frame assembly is fabricated from galvanized metal.

5. The portable curing frame of claim 1 wherein said portable frame assembly is fabricated from aluminum, PVC, or a plastic material.

6. The portable curing frame of claim 1 further comprising vertical support members and arm support members to support said arm members, said arm support members being attached to said vertical support members.

7. A portable tobacco barn to receive and hold harvested tobacco stalks on curing rods, comprising:
a portable frame assembly including a set of arm members to support curing rods holding harvested tobacco stalks; and
a protective cover sheet to cover said portable frame assembly.

8. The portable curing frame of claim 7 wherein said arm members are fabricated from wood.

9. The portable curing frame of claim 7 wherein said portable frame assembly is fabricated from wood.

10. The portable curing frame of claim 7 wherein said portable frame assembly is fabricated from galvanized metal.

11. The portable curing frame of claim 7 wherein said portable frame assembly is fabricated from aluminum, PVC, or a plastic material.

12. The portable curing frame of claim 7 further comprising vertical support members and arm support members to support said arm members, said arm support members being attached to said vertical support members.

13. A method of harvesting tobacco, comprising:
supplying a portable frame assembly including a mid-level set of arm members to support curing rods with affixed harvested tobacco stalks and a top-level set of arm members to support curing rods with affixed harvested tobacco stalks;
delivering said portable frame assembly to a field of tobacco plants;
affixing harvested tobacco stalks to curing rods;
loading said curing rods with affixed harvested tobacco stalks onto said mid-level set of arm members to support curing rods with affixed harvested tobacco stalks and said top-level set of arm members to support curing rods with affixed harvested tobacco stalks;
covering said portable frame assembly with a protective cover sheet, said protective cover sheet covering the top and sides of said portable frame assembly, said protective cover sheet having corners;
tying down said corners of said protective cover sheet with fastening devices; and
removing the portable frame assembly from the field of tobacco plants.

14. The method of claim 13 wherein said portable frame assembly is fabricated from wood.

15. The method of claim 13 wherein said portable frame assembly is fabricated from galvanized metal.
